(19) United States
(12) Patent Application Publication
(10) Pub. No.: US 2017/0043807 A1
(43) Pub. Date: Feb. 16, 2017

(54) TRAILER BACKING UP SYSTEM DISPLAY

(71) Applicant: Daniel Robert Shepard, Stratham, NH (US)

(72) Inventor: Daniel Robert Shepard, Stratham, NH (US)

(21) Appl. No.: 15/234,429

(22) Filed: Aug. 11, 2016

Related U.S. Application Data
(60) Provisional application No. 62/203,463, filed on Aug. 11, 2015.

(51) Int. Cl. B62D 15/02; B60Q 1/30

(52) U.S. Cl. CPC B62D 15/029; B60Q 1/305

(57) ABSTRACT

The present invention relates to display means for systems for guiding a trailer while backing, and in particular to graphical display means to provide information to an operator who is steering, and controlling the accelerator and breaks. The present invention is also a means and a method for enabling or disabling alerts on the display (and audible) based on the motion of the vehicle.

### CROSS-REFERENCE TO RELATED APPLICATION

This Patent Application makes reference to and claims the benefit of U.S. Provisional Patent Application 62/203,463 by Shepard titled “TRAILER BACKING UP SYSTEM DISPLAY” that was filed on Aug. 11, 2015 and that application is incorporated herein in its entirety by reference; this Patent Application also makes reference to U.S. Pat. No. 7,715,953 (the '953 patent) by Shepard titled “TRAILER BACKING UP DEVICE AND METHOD” which issued on May 11, 2010 and U.S. patent application Ser. No. 13/507,671, by Shepard titled “TRAILER BACKING UP DEVICE AND TABLE BASED METHOD” that was filed on Jul. 18, 2012 and U.S. patent application Ser. No. 14/791,283, by Shepard titled “PORTABLE TRAILER GUIDANCE SYSTEM” that was filed on Jul. 3, 2015 and those applications are incorporated herein in their entirety by reference.

### TECHNICAL FIELD

In various embodiments, the present invention relates to systems for guiding a trailer while backing and, in particular, the present invention relates to the displays used with systems for guiding a trailer while backing.

### BACKGROUND

Trailers have been around for many years, yet every summer and winter one can observe the owners of boats and snowmobiles, respectively, backing up those devices on trailers with great difficulty. The problem arises from the fact that a trailer being backed-up is an inherently unstable system. A trailer being pushed wants to turn around and be pulled (i.e., to jackknife) instead. To compensate for this instability, the driver must skillfully alternate the direction of his steering so as to cause the trailer to want to turn around and be pulled from opposite sides thereby repeatedly crossing the centerline of the pushing vehicle. Various innovations have been introduced to address this problem in whole or in part. Prior art reveals several attempts to address the problems associated with backing a trailer. The simplest solutions address parts of the problem ranging from ways of sensing the angle of the hitch (see: Kollitz, U.S. Pat. No. 4,122,390), to sensing and displaying the angle of the hitch (see: Gavit, U.S. Pat. No. 3,833,928), to sounding an alarm when a jackknife condition exists or is imminent (see: Kimmel, U.S. Pat. No. 4,040,006). While these solutions are helpful, they only each address a part of the backing problem. Shepard in his U.S. Pat. No. 7,715,953 teaches a complete working system. However, in that teaching, some new needs arise that are addressed by the teaching of the present invention, such as how to install a complete working system as an after market product that can easily be installed or removed and how to install a sensor for measuring the angle formed between the centerline of the vehicle and the centerline of the trailer (i.e., the hitch angle sensor or, as it is sometimes also known, the articulation angle sensor) such that it does not interfere or collide with the trailer tongue or any other parts of the hitching system. In particular, an angle sensor is needed that can get its measurement in-line with the axis of rotation of the trailer tongue upon the hitch ball (i.e., to measure the articulation angle of this hitch joint) without actually being located at that axis of rotation. This hitch angle sensor, in particular, must be designed not to be damaged either during hitching up a trailer (due to a collision between the hitch and sensor with a part of the trailer) nor while towing on the highway (due to kicked up debris).

Trailer guidance systems such as the portable system disclosed in U.S. patent application Ser. No. 62/020,526, by Shepard titled “PORTABLE TRAILER GUIDANCE SYSTEM” that was filed on Jul. 9, 2014 require sensors for detecting the hitch angle and the turning radius and output means for displaying the intended trailer destination. Most vehicles do not have integral turning sensors and most trailers and/or hitches do not have integral hitch angle sensors. A solution is to make a hitch angle sensor that can be added to an existing vehicle that did not have such capability leaving the automotive assembly line. Once such an investment in a hitch angle measurement sensor is made, it is possible to leverage this sensor for not only measuring the angle of the hitch, but to also adapt the angle measuring mechanism of the hitch angle sensor to create a guidance mechanism to assist a driver in backing up the vehicle in order to couple the vehicle to the trailer.

### SUMMARY

The present invention relates to displays to assist a driver while guiding a trailer, and in particular to trailer back-up system displays that can be utilized for indicating the direction of a trailer and the position of a trailer relative to a coupled vehicle.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawing, in which:

FIG. 1 depicts a hitch ball mounted on a hitch ball mount.

FIG. 2 depicts a hitch angle sensor adaptor plate in accordance with various embodiments of the invention.

FIG. 3 depicts an x-ray view of the hitch angle sensor adaptor plate in accordance with various embodiments of the invention.

FIG. 4 depicts a hitch angle sensor adaptor plate mounted between a hitch ball and a hitch ball mount in accordance with various embodiments of the invention.

FIG. 5 depicts a stethoscope and wishbone interconnect in accordance with various embodiments of the invention.

FIG. 6 depicts a coupled hitch ball and trailer tongue.

FIG. 7 depicts a generalized image of the hitch angle sensor being utilized for directional guidance of the hitch ball towards the trailer tongue in accordance with various embodiments of the invention.

FIG. 8 depicts a display for guiding a user while backing with a trailer.

FIG. 9 depicts a display for guiding a user while backing with a trailer during the special condition when the vehicle and trailer are inline.

FIG. 10 depicts a display for guiding a user while backing with a trailer showing additional display features.

FIG. 11 depicts a display for guiding a user while backing with a trailer showing an alternate display approach to that depicted in FIG. 10.

### DETAILED DESCRIPTION

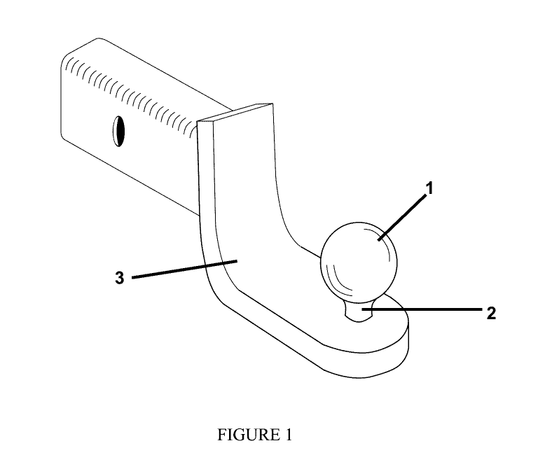

The present invention relates to displays to assist a driver while guiding a trailer, and in particular to trailer back-up system displays that can be utilized for indicating the direction of a trailer and the position of a trailer relative to a coupled vehicle. FIG. 1, illustrates a typical hitch ball mount with a hitch ball mounted. The hitch ball 1 is typically a solid metal sphere with a stem 2 extending from the bottom of the ball and whereby the bottom portion of the stem is threaded. The hitch ball mount 3 has a corresponding hole through it to enable inserting the threaded stem to pass through the hitch ball mount and be secured from below with a hitch ball nut.

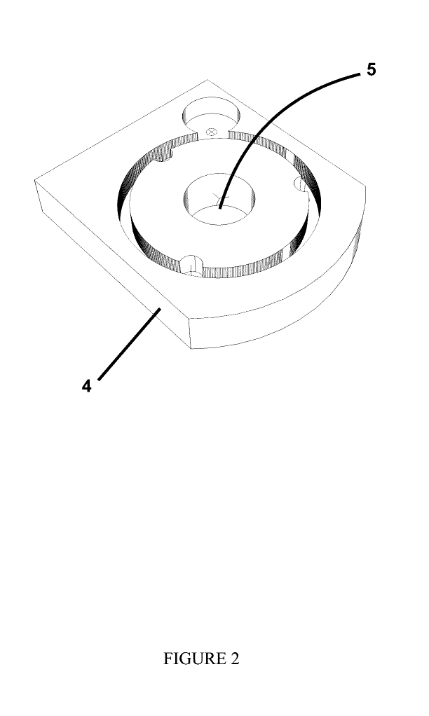

FIG. 2 shows a possible configuration of an adaptor plate 4 according to the present invention. This plate has a hole 5 that matches the hole in the hitch ball mount such that the adaptor plate can be inserted between the hitch ball and hitch ball mount when the hitch ball is secured to the mount. This will secure the adaptor plate between the ball and the mount. The plate must not be significantly thicker than the amount of threaded stem that is exposed below the hitch ball nut when the hitch ball in mounted without the adaptor plate. This will enable an existing hitch ball and hitch ball mount to be separated and then reattached with the adaptor plate in between. This approach will serve to keep costs low while keeping shipping costs low. By selling only the adaptor plate to be added to an existing hitch ball and hitch ball mount, the weight of the product being shipped is greatly reduced (the hitch ball and the hitch ball mount are both made from heavy steel or other metal and would be costly to ship).

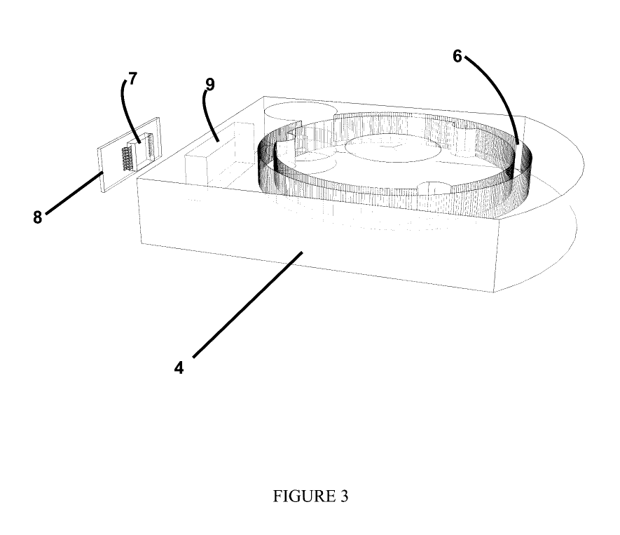

As shown in FIG. 3, the adaptor plate 4 has a circular groove 6 in which a toothed ring is mounted on supporting spacers. This toothed ring will match the teeth of a gear mounted on a shaft in a circular recess in the top corner. This shaft goes through a hole to another gear which turns a final gear assembly that supports a diametrically magnetized permanent magnet that is sensed by a rotation sensor integrated circuit such as the Austrian Microsystems AS5040. Electronic circuitry 7 can be mounted on a board 8 that is mounted in a recess 9 at the back of the adaptor plate 4. This circuitry may also include wired or wireless connection to the backup guidance system (a wired connection could be made through the trailer wiring harness and a wireless connection could be implemented using a Bluetooth communications link, a WiFi communications link, a ZigBee communications link, a radio link or any other wireless connection using any wireless communications standard); power could be provided through the wiring harness or through the use of a battery.

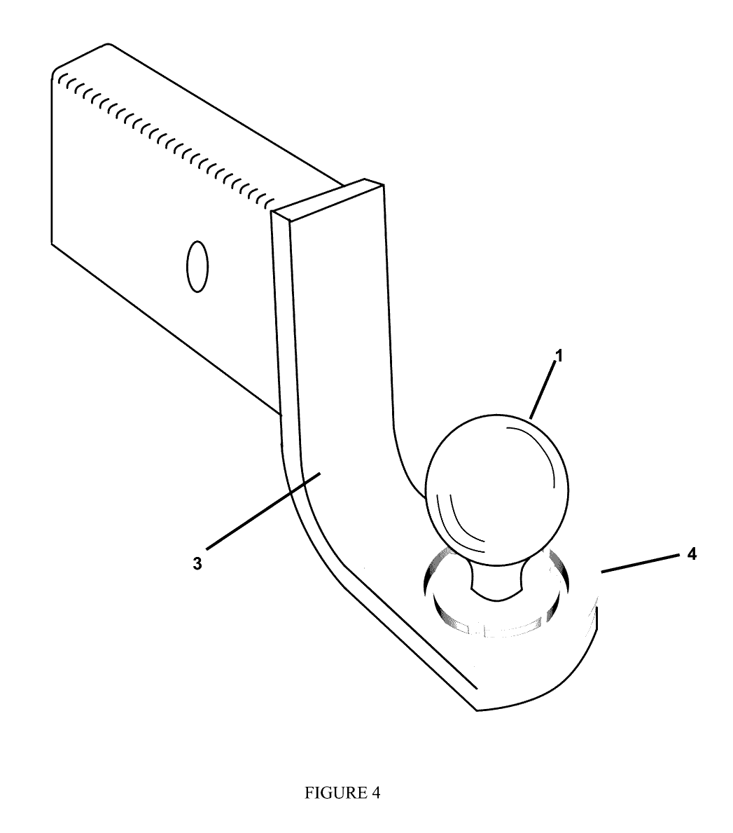

FIG. 4 depicts the adaptor plate 4 after it is fastened between the hitch ball 1 and the hitch ball mount 3. Optionally to prevent the adaptor plate from twisting and becoming misaligned while tightening the hitch ball nut, a textured surface can be incorporated into the bottom surface of the adaptor plate. The adaptor plate is made of a hard material such as steel so that it can withstand the compression from the hitch ball after tightening the hitch ball nut and also so that it can survive any accidental collision with a trailer tongue during vehicle to trailer coupling. Likewise, the recess for the toothed ring is to protect the toothed ring from corresponding damage. To prevent corrosion from forming over time and interfering with the smooth rotation of the toothed ring and its matching gear and supporting spacers, stainless steel is recommended. Many sensing circuits and mechanical configurations will be apparent to those skilled in the art in light of the present teaching.

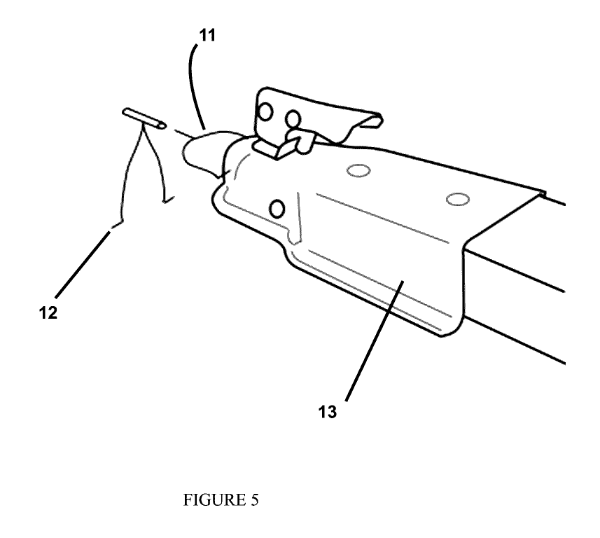

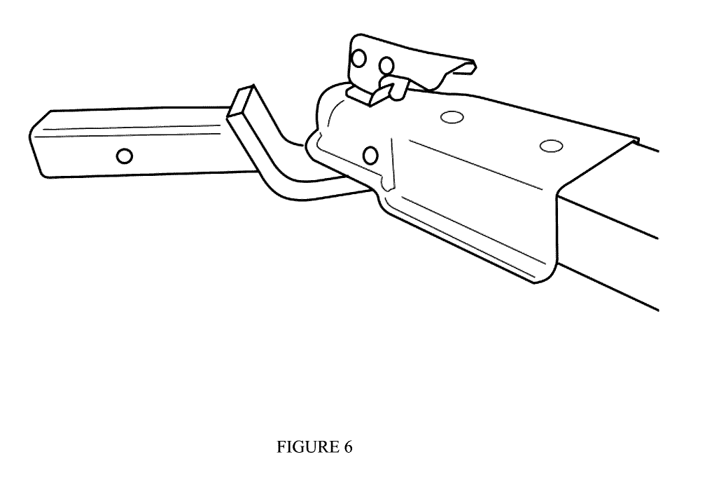

FIG. 5 depicts a stethoscope 10 and wishbone 11 pin to connect the trailer tongue 12 to the toothed ring. In this way, as the hitch angle changes, the stethoscope and wishbone pin will cause the toothed ring to rotate in the circular groove thereby causing the mechanical coupling to turn the magnet which is sensed by the electronics. The stethoscope and wishbone pin is designed to be very inexpensive to make its replacement if lost non-costly. The stethoscope portion connects to the tongue on opposite sides of the hitch ball equator either by drilling a small matching mating hole on each side of the tongue's coupler or by attaching a supporting plate to either side of the tongue's coupler with each plate having a similarly located matching mating hole (these supporting plates can be mounted by removing the bolts that fasten the coupler to the tongue and reinserting those bolts with the supporting plates inline as will be understood by those skilled in the arts). The stethoscope is made from a springy wire and will snap into place in the matching mating holes with the spring pressure from opposite sides of the coupler providing enough pressure to hold it in place while still enabling the stethoscope to rotate in place in the matching mating holes. This ability to rotate in place will allow the trailer to pitch up and down (where yaw is the hitch angle being measured) affecting the hitch angle measurement and without causing the stethoscope and wishbone pin to be dislodged. The neck of the stethoscope inserts into a tube whereby the neck can rotate freely within the tube without excessive looseness or lash. This ability to rotate in place will allow the trailer to roll without affecting the hitch angle measurement and without causing the stethoscope and wishbone pin to be dislodged. The wishbone piece comprises the tube and two legs. These two legs hold their opened position due to the springiness of the wire, but enable a user to pinch the two legs together such that the two feet can be inserted into a slot in the toothed ring and when the pinch is released, the two feet will engage holes in either ends of that slot in the toothed ring to hold the wishbone in place. The stethoscope can be formed from a single piece of wire where the neck portion is formed first by bending the wire back against itself and then parting the two ends out and around the coupler. The wishbone can also be formed from a single piece of wire the same or similar type of wire by coiling the wire to form the tube portion and then down and apart to form the two legs. By fabricating the stethoscope and wishbone pin in this was, the cost of this component can be kept very low making replacement if lost very affordable. FIG. 6 shows the coupler coupled to the hitch ball.

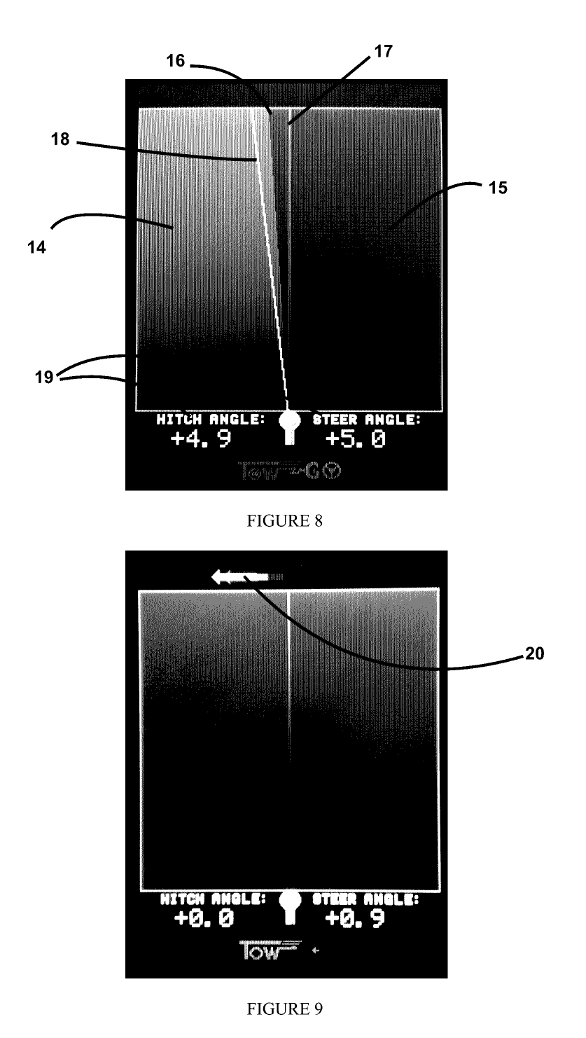

A means to display the system in action is a necessary part, particularly when operating without servo controlled steering (i.e., when the operator is controlling the steering, throttle and break). FIG. 8 depicts one such display wherein the graphical representation is of the area behind the vehicle and trailer (complete with a representation of the hitch ball location). Typically, this display is a hand-held or a portable device (such as a smart phone like an iPhone or a tablet like an iPad, or some other portable or mobile device such as a laptop computer, or a portable computer) that is wirelessly connected to the trailer backup system (a wired display device could also be used but with less convenience). For a wireless display device, the wireless link could be affected using WiFi, Bluetooth, ZigBee, or any of a number of commercially available wireless protocols or a proprietary protocol using the same or other radio, visible light, invisible light communications. This display component will communicate with other components of the system such as the electronics proximate to the hitch to contribute to the determination of the hitch angle, electronics proximate to the steering to contribute to the determination of the turning radius of the vehicle, or other electronics or computing components for performing calculations or otherwise contributing to the determination of the trailer's predicted direction.

The background color of the display indicates the range 14 that is directly within reach of the guided trailer (green) as well as the range 15 that would require at least one reversing maneuver to reach (red). The boundary 16 between these two areas corresponds to the current trailer direction (a.k.a. the trailer centerline boundary, TCB, or the hitch angle line) and the angle between this boundary and the gray centerline 17 is the current hitch angle. The superimposed white line 18 corresponds to the current predicted direction where the vehicle would become inline with the trailer given the current position of the steering wheel. In operation, the driver would backup the trailer until the while line is showing the direction corresponding to the desired destination for the trailer. As the vehicle and trailer are backed up, the trailer will turn towards the white line and the vehicle will turn (at a faster rate) towards the trailer. Since the vehicle will be converging on the direction of the trailer, the hitch angle will be getting smaller and the display graphic will appear to rotate so as to bring the TCB to the center of the display (i.e., towards the gray centerline, which does not move). As the hitch angle changes, the driver will adjust his or her steering by observing the white line to keep the trailer on course towards the intended direction. Also on this display, the hitch angle as currently measured and/or other system values (such as the steering angle, the prediction angle, the steering wheel angle, the front wheels angle, the trailer length, the wheel base, or the like) can optionally be shown numerically at the bottom of the display 19.

A special case exists when the vehicle and trailer are in direct alignment. In this case, the prediction white line will coincide with the gray center line and the TCB. However, even though the all the lines are centered in the display, the position of the steering wheel will determine in which direction the trailer will break away from this alignment as backing occurs. Many people backing a trailer without a system such as the present invention are familiar with the notion of steering the trailer by holding the steering wheel at the bottom of its circle and moving that point in the direction he or she desires the trailer to go. With the present invention, a corresponding visual aid is present as is shown in FIG. 9. As the steering wheel is moved, an arrow or an animated indicator 20 (or any other form of display graphic including the sign on a numeric value) should be provided to show the direction in which the trailer will turn as backing proceeds.

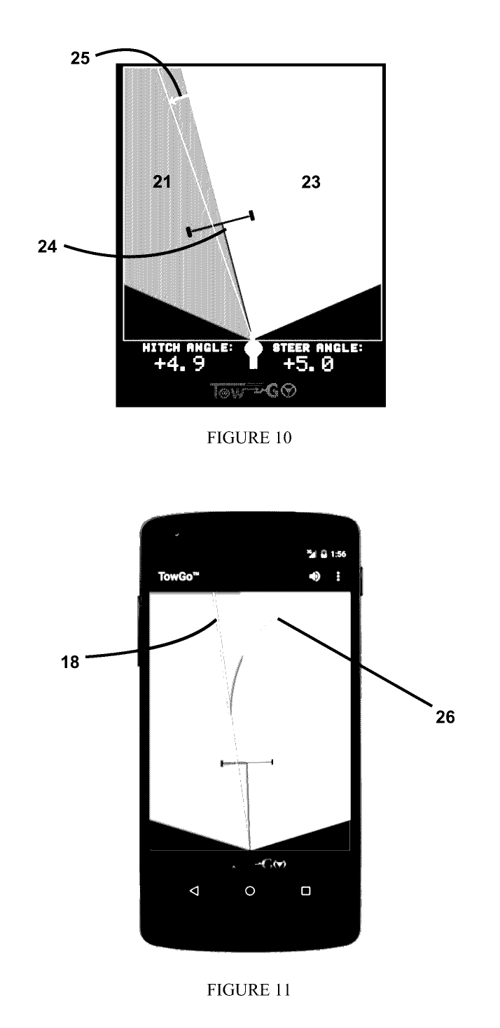

Other display feature options are shown in an alternate display approach in FIG. 10. In this figure, the background colors are adjusted to use green for any area 21 that can be reached without an additional maneuver, red for areas 22 that cannot be reached, and yellow for multi-maneuvered areas 23. In addition to colored zones, a graphical representation of a trailer viewed from above 24 is added to make the TCB easier to visualize. (The software programming techniques for generating the graphical display images discussed herein are well know and understood by those skilled in the art of graphics programming.)

There are three limits of particular interest in this system. The first limit is a collision range that corresponds to the trailer or the towed item making contact with a corner or other point on the towing vehicle (the Hitch Angle Collision Limit, or HACL) and is a function of the shape of the trailer and the hitch angle. This limit is dependent on what is being towed and can be provided by the driver as a user input to the system. For example, if a boat is being towed, the trailer (i.e., via the hitch angle) might be allowed to turn a good bit greater than if a camper is being towed because the pointed bow of a boat gives more turning room than a squared-off camper. Furthermore, the maximum allowable hitch angle value might be different for the left side and right side turning (e.g., if the camper had a propane bottle on one side, contact with the vehicle might occur soon than if turning to the other side), in which case, the driver might set these two inputs individually (a left HACL and a right HACL). This first limit can be displayed by adding triangular areas 22 in the bottom left and bottom right corners of the image.

A second limit corresponds to where the steering wheel is turned to its maximum range (wheel lock) thereby preventing the vehicle from being turned any greater (i.e., more sharply). When backing with a trailer, a very tight or small turning radius (corresponding to having the wheels of the vehicle sharply turned towards the trailer far to the left or right) will result in the vehicle turning onto the current path of the trailer very quickly (such that the direction of the trailer changes very little before the vehicle comes in line with the trailer). Wheel lock limits how tight the vehicle's turning radius can be and, as a result, there is a small range between the current trailer direction and the nearest predicted direction of the vehicle and trailer becoming aligned corresponding to the wheel lock turning radius. This small range corresponds to the amount the trailer will turn before the vehicle becomes aligned with the trailer when the vehicle is turned as sharply towards the trailer as possible (i.e., turned to wheel lock) and for other than larger hitch angles, this range is generally slight or imperceptible. This second limit can be displayed by including the area between the current hitch angle line and a line representing the predicted direction when the steering is turned to wheel lock to the yellow multi-maneuvered area (shown to the right of the hitch angle line in the figure).

A third limit is in a sense the opposite of the second limit and corresponds to the vehicle not being turned enough. At any instant while the vehicle and trailer are backing up, the trailer is both backing and turning (as described in the '953 patent) and if the vehicle's turning radius is less than the instantaneous turning of the trailer (i.e., the turning radius of the trailer which is generally the trailer length divided by the tangent of the hitch angle), the vehicle and the trailer will not converge to alignment. If the turning radius of the vehicle is less than this turning radius of the trailer, this will lead to a jackknife condition if a steering correction is not made. However, there may be times during backing when it could be desirable to have the vehicle's turning radius be equal to (or less than) the trailer's turning radius; when the vehicle's turning radius is equal the trailer's turning radius, the driver would achieve an infinite backing angle (IBA) and the trailer could be backed continuously until a desired direction is generally achieved because the hitch angle would neither increase nor decrease. (The IBA is generally equal to the arctangent of the product of the tangent of the hitch angle, h, and the ratio of the vehicle wheelbase, w, to the trailer length, L, i.e., IBA=arctan(Tan(h)*w/L); IBA is a function of the hitch angle and is independent of the vehicle's turning radius.) A user of the system should typically avoid having the prediction direction white line cross into this area where the vehicle's rate of convergence towards the trailer falls short of the rate at which the trailer turns away. With the hitch angle neither increasing nor decreasing, the trailer and vehicle will not be converging on becoming aligned with this limit and any angle predicting the direction in which the vehicle and trailer will become aligned will be undefined with the result being the prediction direction white line can not be made visible in the display.

For greater user friendliness, the display can incorporate a few additional features. An arrow 25 (shown curved near the top of FIG. 10) can be incorporated that points from the TCB to the prediction direction white line as a constant reminder of motion of the trailer's changing direction (relative to the ground). An image of a trailer can also be superimposed on the TCB to reminds the user of where the trailer actually is any moment and this trailer image might also be customizable to reflect a variety of trailers (one axel, two axel, etc. or by type such as utility trailer, boat trailer, camper, horse trailer, trailer with bumpers verses rollers, and the like) and this might trailer type image be further customizable to reflect the item that is being trailered (a boat, snowmobiles, jet skis, motorcycles, and so on). A visual jackknife alert could be provided, such as a flashing word “JACKKNIFE” superimposed on the display (in addition to any audio alert), when the trailer turning radius exceeds the vehicle turning radius. A visual collision alert could be provided, such as a flashing word “COLLISION” superimposed on the display (in addition to any audio alert), when the prediction direction white line enters the red zones. Under any jackknife condition, the trailer wants to turn around and be pulled resulting in a prediction direction of 180° which would cause the white line not to be visible (i.e., it is rotated off screen).

FIG. 11 depicts an additional variation on a backup system display screen. Notably present in this view is a curved blue line 26 drawn from near the center of the white prediction line to the opposite side of the display from that on which the white prediction line 18 is shown. This blue line 26 represents the current turning radius of the vehicle and is an indication of how quickly the trailer will begin to turn to the opposite side of the vehicle upon reaching alignment with the vehicle. The curvature of this blue line 26 will be more curved with a tighter turning radius and will become more straightened as the turning radius is less tight. When alignment of the vehicle and the trailer is achieved, to position of the vehicles steerable wheels determined the turning radius and this turning radius determines how quickly the trailer will deviate from its just attained, aligned position. This indication of the vehicle's turning radius sharpness is useful to aid the driver in gauging the extent of a potential overshoot of the trailer direction following achieving alignment. Naturally, any item color can be changed as desired for all displays, above.

The display may show additional items reflecting other information. As described in U.S. patent application Ser. No. 14/791,283, by Shepard titled “PORTABLE TRAILER GUIDANCE SYSTEM” that was filed on Jul. 3, 2015, it is anticipated that this system will be used in conjunction with a steering wheel mounted turning sensor. In particular, it is anticipated that this steering sensor will incorporate an Inertial Measurement Unit (IMU) to sense the rotation of the steering wheel with the IMU's gyroscopes (as is well known and understood by those skilled in the art of IMU operation and programming, the gyroscopes and accelerometers incorporated in an IMU can be used together to obtain a more accurate rotation position value). However, the Accelerometers within the IMU can also be used to collect motion data indicating the changing position of the vehicle (i.e., the accelerometers will provide an indication of when the vehicle is in motion, whether that motion is forward or reverse, and the rate of acceleration or deceleration). For example, with this additional data, the display can incorporate additional features to indicate the rate of convergence of the TCB to the prediction direction white line (e.g., the curved arrow could be animated to grow from the TCB to the prediction direction white line and the speed of this animation could reflect how quickly the vehicle will become inline with the trailer), or any jackknife alarms could be suppressed while the vehicle is not in motion. Other alarms could likewise be suppressed such if a distance sensing device (such as an ultrasonic range sensor similar to that sold by Radio Shack, part number 2760342 which can measure distance from 3 cm to 4 meters) were to be incorporated at the corners of the vehicle and trailer to detect an object with which the vehicle or trailer could collide. For example, a collision alert for an object in the path of the vehicle but that is ahead of the vehicle could be suppressed if the vehicle is motionless or backing up.

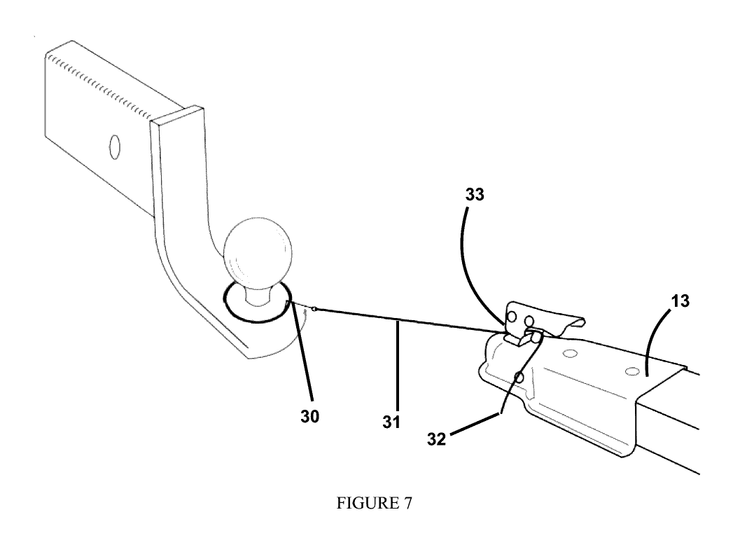

A challenge in trailering second to backing up with the trailer attached is coupling the trailer to the hitch. The vehicle on which the hitch is mounted must be backed up to the trailer coupler on the end of the trailer tongue very precisely. This is typically done with an assistant. The assistant must verbally direct the driver of the vehicle in how far to back up and in what direction to turn to bring the hitch ball into proper alignment for coupling. Such verbal directing can be a challenge. However, it is an aspect of the present invention that the same electronics and/or mechanics of the hitch angle sensor can be utilized to provide the driver with precise information of the direction aspect of the coupling maneuver. To do this, as is generally depicted in FIG. 7, a wishbone spring 30 attached to a line 31 (or string or cord or wire or filament or the like) is snapped into the toothed ring and the end of the line 32 is pulled through a hole 33 in the trailer coupler 13. The assistant now would only need to pull on the line to keep it taught (without pulling so hard as to pop the wishbone out of the toothed ring) and to instruct the driver on how far to back up. The driver would read the hitch angle on the back up guidance system (either numerically or graphically or in other forms that will be apparent to those skilled in the are in light of the present teaching—for example the display might only indicate when the hitch angle is straight and if not straight, to which side of straight the direction is).

It is an aspect of the present invention that a distance sensing device could be incorporated to eliminate the need for the assistant to verbally indicate the distance remaining to be backed. For example, an ultrasonic range sensor such as that sold by Radio Shack (part number 2760342 which can measure distance from 3 cm to 4 meters) could be mounted on the wishbone and line assembly such that the range sensor would be supported to the opposite side of the hitch ball from that of the line and pointing in the direction of the line. In this way, as the direction changes, the range sensor will be maintained pointing in the direction of the trailer coupler (i.e., pointing down the line). The distance measured by the range sensor would be displayed on the back up guidance system (either numerically or graphically or in other forms that will be apparent to those skilled in the are in light of the present teaching).

A variation on the present invention would be to have a motorized winder automatically maintain the tension on the line thereby eliminating the need for an assistant to manage the line. Another variation on the present invention would be to place an ultrasonic transducer (for transmitting) onto the coupler and have two ultrasonic transducers (for receiving) either placed on either side of the hitch sensor equally spaced from the hitch sensor or placed one at the hitch sensor and one to the side of the hitch sensor such that the direction can be discerned by the delay in the received signal between the two receiving transducers. The transmitting transducers could be magnetically attached to the top of the ball socket of the coupler on the trailer. In addition to determining the direction, the distance to the coupler could also be discerned through triangulation; this triangulation could be calibrated by initially placing the transmitting transducer on top of the hitch ball before moving it to the coupler on the trailer. While the transmitting transducer would be battery operated, the receiving transducers would still leverage the electronics of the hitch sensor for power and communication with the back up guidance system on which display the coupling guidance distance and direction information would be indicated.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

I claim:

1. A display for use with a system to back up a trailer by a towing vehicle comprising a graphical component for indicating a hitch angle, a predicted direction and one or more of (i) an indication of the angular direction a trailer will turn from a straight line position, (ii) a range of angles in which the trailer and tow vehicle will collide, (iii) an animated indication of how fast the vehicle will become inline with the trailer, (iv) an indication of potential directions that cannot be reached.

2. The display of claim 1 whereby the range in which the trailer and tow vehicle will collide can be different on either side of the vehicle.

3. The display of claim 1 further comprising an alerting mechanism to indicate one or more of a jackknife condition or an object collision to an operator.

4. The alerting mechanism of claim 3 whereby the alerting mechanism is suppressed when the vehicle is not in motion.

5. The system to back up a trailer by a towing vehicle of claim 1 further comprising a sensor for providing data on the motion of the vehicle.

6. The sensor of claim 5 comprising an inertial measurement device. The data on the motion of the vehicle of claim 5 comprising an indication of the vehicle's moving forward or backing up.

8. The alerting mechanism of claim 7 further comprising an alerting mechanism to indicate one or more of a jackknife condition or an object collision to an operator.

9. The alerting mechanism of claim 8 whereby the alerting mechanism due to an object collision is suppressed when the object is not in the path of the vehicle or trailer.

10. The graphical component of claim 1 whereby the graphical component is a portable device, a mobile device, a smart phone, a tablet, a laptop computer, or a portable computer.

11. The system to back up a trailer by a towing vehicle of claim 1 comprising communication between the graphical component and one or more other components.

12. A method for displaying information to a vehicle operator affecting the backing up a trailer comprising the steps of (i) receiving data from one or more of a component attached to a vehicle or a component attached to a trailer, (ii) extracting one or more values from the data received, (iii) generating a graphical representation of the one or more values to be viewed by the vehicle operator.

13. The method of claim 12 further comprising the step of having the vehicle operator adjust the vehicle steering based on graphical representation viewed.

14. The method of claim 13 whereby the adjustment to the vehicle steering facilitates guiding the trailer to an intended destination.

15. The method of claim 12 whereby receiving data comprises communicating wirelessly.

16. The method of claim 15 whereby communicating wirelessly comprises using a communications standard selected from the list of: WiFi, Bluetooth, ZigBee, or a radio link.

17. The method of claim 12 further comprising the step of displaying an indication of directions that cannot be reached directly.

18. The method of claim 12 further comprising the step of displaying an indication of directions that may result in contact between the vehicle and the trailer or trailered item.

19. The method of claim 12 further comprising the step of alerting the vehicle operator by providing a visual or an audio alert.
